(19) United States
(12) Patent Application Publication
(10) Pub. No.: US 2015/0042898 A1
(43) Pub. Date: Feb. 12, 2015

(54) DISPLAY DEVICE AND TELEVISION RECEPTION DEVICE

(71) Applicant: Sharp Kabushiki Kaisha, Osaka (JP)

(72) Inventor: Jo Ikuta, Osaka (JP)

(73) Assignee: Sharp Kabushiki Kaisha, Osaka (JP)

(21) Appl. No.: 14/379,882

(22) PCT Filed: Feb. 15, 2013
(86) PCT No.: PCT/JP2013/053647

§ 371 Date: Aug. 20, 2014

(30) Foreign Application Priority Data
Feb. 22, 2012 (JP) 2012-036102

(51) Int. Cl. F21V 8/00; H04N 5/64

(52) U.S. Cl. CPC G02B 6/0085; G02B 6/0091; H04N 5/64
USPC 348/790; 349/65; 362/611

(57) ABSTRACT

This liquid crystal display device is provided with: an LED; a liquid crystal panel; a light guide plate; a metal chassis disposed on the reverse side of the light guide plate from the liquid crystal panel, the chassis having a step provided by bending a bottom plate, and the bottom plate being sectioned into a first bottom plate part and a second bottom plate part by the step; an LED substrate attached to the first bottom plate part, the LED being arranged on a plate surface of the LED substrate; and a frame for accommodating the liquid crystal panel, the LED, the light guide plate, and the LED substrate so as to enclose these accommodated components between the frame and the first bottom plate part while abutting the second bottom plate part, the frame being arranged on a display surface side with respect to the liquid crystal panel. By the present invention, the temperature of the frame can be prevented from becoming too high in a display device of a type not provided with a cabinet. The present invention is used in a television reception device.

### TECHNICAL FIELD

The present invention relates to a display device and a television receiver.

### BACKGROUND ART

In recent years, flat panel display devices that use flat panel display elements such as liquid crystal panels and plasma display panels are replacing cathode ray tube displays in display elements for image display devices such as television receivers, allowing image display devices to be made thinner. Liquid crystal panels used in liquid crystal display devices do not emit light on their own, and therefore, it is necessary to provide a separate backlight device as an illumination device.

When a light source emits light in a backlight device, heat is generated on the light source substrate on which the light source is mounted. As a result, the heat generated on the light source substrate needs to be effectively dissipated to outside of the backlight device. An edge-lit backlight device that can effectively dissipate heat generated on the light source substrate as explained is disclosed in Patent Document 1, for example.

### RELATED ART DOCUMENT

### Patent Document

Patent Document 1: Japanese Patent Application Laid-Open Publication No. 2010-170922

### Problems to be Solved by the Invention

However, in recent years, because of demands for lower manufacturing cost, even thinner devices, and the like, elimination of the synthetic resin cabinet that is an exterior member of the liquid crystal display unit is being considered, but for a liquid crystal display device without a cabinet, the frame supporting the liquid crystal panel is the same as the frame forming the exterior of the liquid crystal display unit, the frame being accessible. Furthermore, usually, a light source is directly or indirectly attached to the frame. As a result, there was a problem for liquid crystal display devices without a cabinet in which the temperature of the accessible frame became excessively high due to the heat generated on the light source substrate being easy to transfer to the frame and the temperature of the frame being easily raised.

The backlight device mentioned above in the Patent Document 1 overlaps with the light source and has sheet-shaped heat dissipating members that extend to the outside of the frame, and thus has a configuration that dissipates the heat generated by the light source to outside. However, problems such as the manufacturing process becoming more complicated and the cost of the materials rising due to the increase in the number of components emerge when trying to apply such heat dissipating members to a liquid crystal display device without a cabinet.

### SUMMARY OF THE INVENTION

The technology disclosed in the present specification was made in view of the above-mentioned problems. The aim of the present specification is to provide a technology with a simple configuration that prevents the temperature from becoming excessively high for an accessible frame of a display device that is not provided with a cabinet.

### Means for Solving the Problems

The technique disclosed in the present specification is a display device, including: a light source; a display panel that performs display with light from the light source; a light guide plate disposed on a side of the display panel opposite to a display surface thereof, the light guide plate being disposed such that an end face thereof faces the light source and guides light from the light source towards the display panel; a chassis made of metal arranged on a side of the light guide plate opposite to the display panel and having a bottom plate, the chassis having a step formed by folding the bottom plate such that the step divides the bottom plate into a first bottom plate part and a second bottom plate part; a light source substrate attached to the first bottom plate part of the chassis, the light source substrate having a light source arranged on a surface thereof; and a frame arranged on a display surface side of the display panel, the frame contacting the second bottom plate part of the chassis and sandwiching the display panel, the light source, the light guide plate, and the light source substrate with the first bottom plate part of the chassis.

The display device mentioned above has a folded portion constituting a step formed between the first bottom plate part and the second bottom plate part. If metal is used here, folding results in bending or cracking, and thus, heat resistance will be higher at the folded portion compared to the flat portion. As a result, in the above-mentioned display device, heat is harder to transfer from the first bottom plate part side to the second bottom plate part side compared to when a continuous flat surface is between the first bottom plate part and the second bottom plate part. Also, in the above-mentioned display device, while the heat generated in the light source substrate attached to the first bottom plate part transfers to the first bottom plate part, because the frame is separated from the first bottom plate part and is in contact with the second bottom plate part, the heat in the light source substrate is difficult to transfer to the frame. Thus, with a simple configuration, the temperature of a frame that is accessible can be prevented from becoming excessively high for a display device that is not provided with a cabinet.

The step may be formed with two folded portions that are folded at a right angle.

According to this configuration, the folded portions between the second bottom plate parts and the first bottom plate part are folded in two locations at right angles respectively, and thus the heat resistance is higher than when the folded portions are folded at an acute angle or at an obtuse angle. This makes it more difficult to transfer the heat from the first bottom plate part to the second bottom plate part, and thus the temperature of the accessible frame can be effectively prevented from becoming excessively high.

The bottom plate may have the first bottom plate part located towards the center of the bottom plate and have the second bottom plate part located towards a side edge of the bottom plate.

According to this configuration, a specific configuration of the display device can be realized in which the outer edge of the frame is in contact with the second bottom plate part and a light guide plate and the like are placed at the central portion of the frame.

A heat dissipating member with heat dissipating characteristics may be interposed between the first bottom plate part and the light source substrate.

According to this configuration, the heat in the light source substrate can be dissipated effectively to the first bottom plate part by the heat dissipating member.

The heat dissipating member may have a bottom face part having a surface arranged along the first bottom plate part and have a side face part that rises vertically from the bottom face part with respect to the bottom face part so as to form an L shape in a cross-sectional view, the light source substrate being arranged on the side face part.

According to this configuration, a specific configuration of a heat dissipating plate can be realized in which the heat of the light source substrate is effectively transferred to the first bottom plate part through the heat dissipating member.

A central portion of the first bottom plate part may have a third bottom plate part that protrudes towards the display panel over a step that is equal to a thickness of the bottom face part of the heat dissipating member.

According to this configuration, the bottom face part of the heat dissipating member and the plate surface of the third bottom plate is arranged on the same flat surface, making it easy for the configuration to support the light guide plate with the bottom face part of the heat dissipating member and the plate surface of the third bottom plate.

The first bottom plate part has a substrate attachment member that is integrally formed with the first bottom plate part and that rises vertically from the first bottom plate part, and wherein the light source substrate is arranged on the substrate attachment member.

According to this configuration, the heat can be easily transferred from the light source substrate to the first bottom plate part without arranging a heat dissipating member.

The light source substrate includes two plate shaped portions forming an L shape in a cross-sectional view, wherein one of the plate shaped portions is arranged along the first bottom plate part, and wherein the other plate shaped portion is provided with the light source.

With this configuration, the heat from the light source substrate can easily transfer to the first bottom plate part without providing a heat dissipating member or a light source attachment member because the light source substrate can be directly attached to the first bottom plate part.

The second bottom plate part may be a portion protruding in a direction opposite to the display panel from the first bottom plate part due to the step.

With this configuration, a light source substrate and a light guide plate can be easily sandwiched between the frame and the chassis compared to a configuration with the second bottom plate part protruding further towards the display panel than the first bottom plate part.

According to the technique disclosed in the present specification, a display device that uses a liquid crystal panel having liquid crystal as the display panel is novel and useful. A television receiver that includes the above-mentioned display device is also novel and useful.

### Effects of the Invention

The technology disclosed in the present specification can prevent the temperature of the accessible frame from becoming excessively high.

### BRIEF DESCRIPTION OF THE DRAWINGS

FIG. 1 is an exploded perspective view showing a schematic configuration of a television receiver TV and a liquid crystal display unit LDU of Embodiment 1.

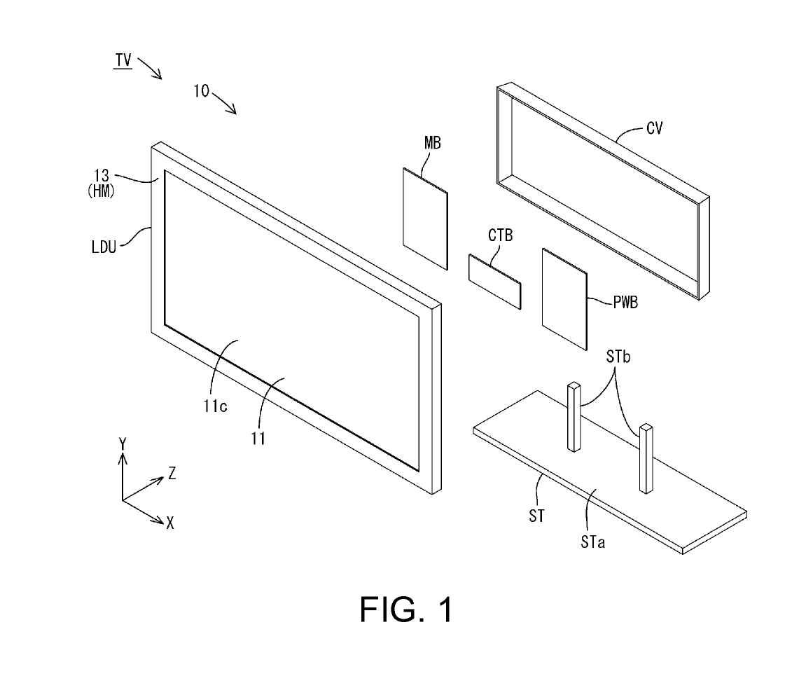

FIG. 2 is a rear view of the television receiver TV and a liquid crystal display device 10.

FIG. 3 is an exploded perspective view showing a schematic configuration of the liquid crystal display unit LDU forming a part of the liquid crystal display device 10.

FIG. 4 is a cross-sectional view that shows a cross-sectional configuration of the liquid crystal display device 10 along the shorter side direction.

FIG. 5 is a cross-sectional view that shows a cross-sectional configuration of the liquid crystal display device 10 along the longer side direction.

FIG. 6 is a cross-sectional view of main parts of the liquid crystal display device 10, in which the vicinity of one of the LED units LU of FIG. 4 is magnified.

FIG. 7 is a cross-sectional view of main parts of a liquid crystal display device 110 in Embodiment 2 showing a cross-sectional configuration of the liquid crystal display device 110 along the shorter side direction, in which the vicinity of one of the LED units LU is magnified.

FIG. 8 is a cross-sectional view of main parts of a liquid crystal display device 210 in Embodiment 3 showing a cross-sectional configuration of the liquid crystal display device 210 along the shorter side direction, in which the vicinity of one of the LED units LU is magnified.

FIG. 9 is a cross-sectional view of main parts of a liquid crystal display device 310 in Embodiment 4 showing a cross-sectional configuration of the liquid crystal display device 310 along the shorter side direction, in which the vicinity of one of the LED units LU is magnified.

### DETAILED DESCRIPTION OF EMBODIMENTS

### Embodiment 1

Embodiment 1 will be described with reference to the drawings. In the present embodiment, a liquid crystal display device (an example of a display device) 10 will be described as an example. Each of the drawings indicates an X axis, a Y axis, and a Z axis in a portion of the drawings, and each of the axes indicates the same direction for the respective drawings. The Y axis direction corresponds to the vertical direction and the X axis direction corresponds to the horizontal direction. Unless otherwise noted, “up” and “down” in the description is based on the vertical direction.

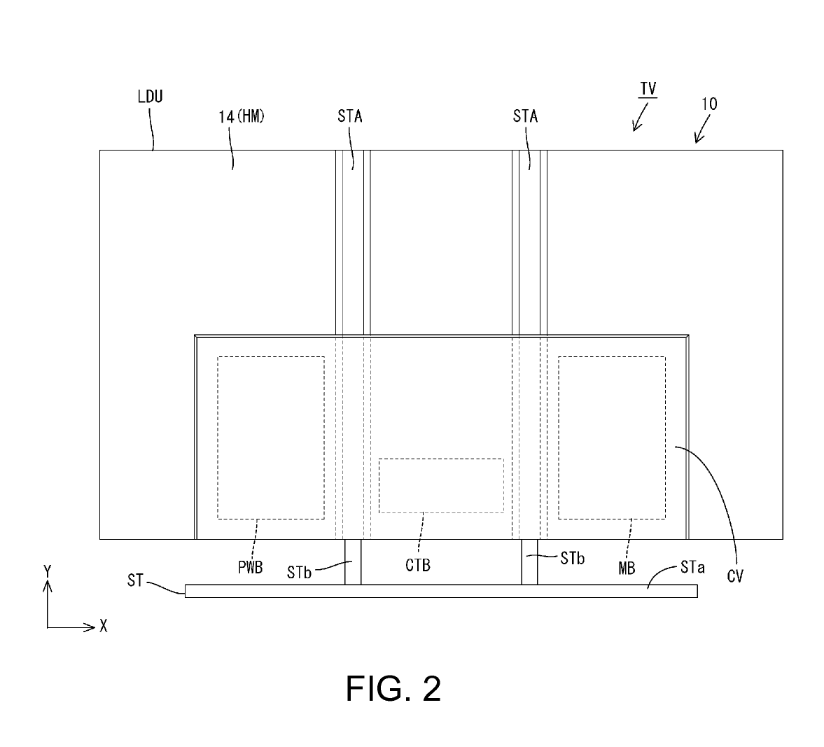

A television receiver TV is constituted of: a liquid crystal display unit LDU; various types of boards PWB, MB, and CTB attached to the back side (rear side) of the liquid crystal display unit LDU; a cover member CV attached to the back side of the liquid crystal display unit LDU and covering the various types of boards PWB, MB, and CTB; and a stand ST. The stand ST holds the television receiver TV in a state in which the display surface of the liquid crystal display unit LDU is in the vertical direction (Y axis direction). The liquid crystal display device 10 of the present embodiment is the portion excluding at least the configuration for receiving television signals (such as a tuner part of the main board MB) from the television receiver TV having the above-mentioned configuration. As shown in FIG. 2, the liquid crystal display unit LDU has a horizontally-long quadrangular shape (rectangular) as a whole, and includes a liquid crystal panel 16, which is a display panel, and a backlight device 12, which is an external light source. These are integrally held together by a frame 13 and a chassis 14, which are external members that constitute the exterior of the liquid crystal display device 10. The chassis 14 of the present embodiment constitutes one of the exterior members and is also a part of the backlight device 12.

First, the configuration of the rear side of the liquid crystal display device 10 will be explained. As shown in FIG. 2, on the rear of the chassis 14 that constitutes the rear exterior of the liquid crystal display device 10, a pair of stand attachment members STA extending along the Y axis direction is attached at two locations that are separated from each other along the X axis direction. The cross-sectional shape of these stand attachment members STA is a substantially channel shape that opens toward the chassis 14, and a pair of support columns STb of the stand ST is inserted into respective spaces formed between the stand attachment members STA and the chassis 14, respectively. Wiring members (such as electric wires) connected to an LED substrate (an example of a light source substrate) 18 of the backlight device 12 run through a space inside of the stand attachment members STA. The stand ST is constituted of a base STa that is disposed in parallel with the X axis direction and the Z axis direction, and the pair of support columns STb standing on the base STa along the Y axis direction. The cover member CV is made of a synthetic resin, and is attached so as to cover approximately half of the lower part of the rear side of the chassis 14 of FIG. 2, while crossing over the pair of stand attachment members STA along the X axis direction. Between the cover member CV and the chassis 14, a component housing space is provided to house the components mentioned below such as the various boards PWB, MB, and CTB.

As shown in FIG. 2, the various boards PWB, MB, and CTB include a power supply board PWB, a main board MB, and a control board CTB. The power supply board PWB is a power source for the liquid crystal display device 10, and can supply driving power to other boards MB and CTB, LEDs (an example of a light source) 17 of the backlight device 12, and the like. Therefore, the power supply board PWB doubles as an LED driver board that drives the LEDs 17. The main board MB has at least a tuner part that can receive television signals, and an image processing part that performs image-processing on the received television signals (neither the tuner part nor the image processing part is shown in the figure), and can output the processed image signals to the control board CTB described below. When the liquid crystal display device 10 is connected to an external video playback device that is not shown, an image signal from the video playback device is inputted into the main board MB, and the main board MB can output the image signal to the control board CTB after processing the signal at the image processing part. The control board CTB has the function of converting the image signal inputted from the main board to a signal for driving liquid crystal, and supplying the converted signal for liquid crystal driving to the liquid crystal panel 16.

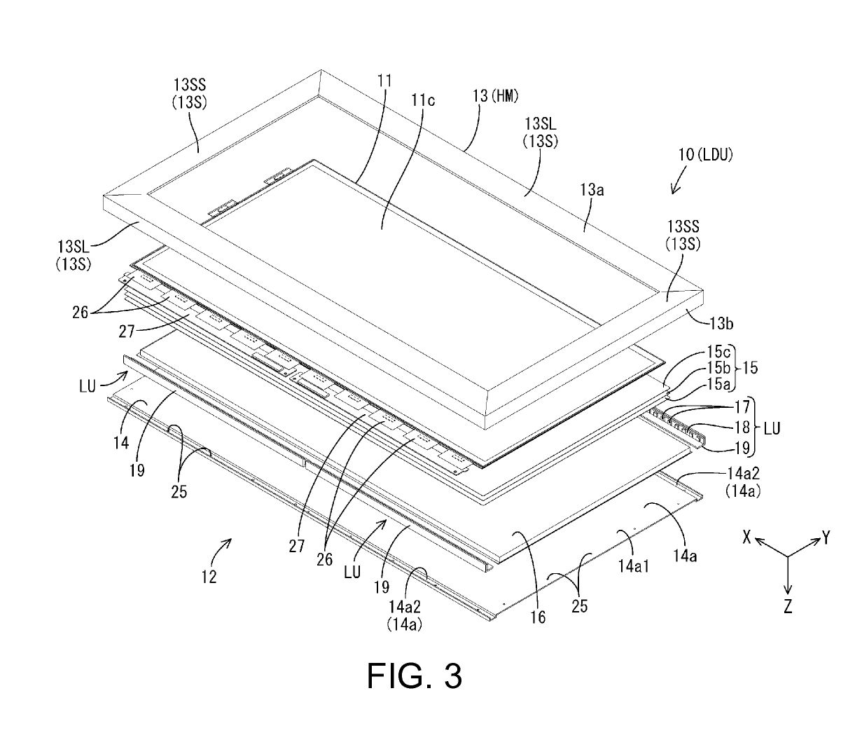

As shown in FIG. 3, the main constituting components of the liquid crystal display unit LDU, which forms a portion of the liquid crystal display device 10, are housed in a space between the frame 13 that constitutes the front exterior of the liquid crystal display device 10, and the chassis 14 that constitutes the rear exterior. The frame 13 is an accessible part in the liquid crystal display device 10, because the frame constitutes the front exterior of the liquid crystal display device 10. The main constituting components housed between the frame 13 and the chassis 14 include at least the liquid crystal panel 11, optical members 15, a light guide plate 16, and LED units LU. Of these, the liquid crystal panel 11, optical members 15, and light guide plate 16 are held by being sandwiched between the frame 13 on the front side and the chassis 14 on the rear side while being stacked one on top of the other. The backlight device 12 is constituted of the optical members 15, the light guide plate 16, the LED units LU, and the chassis 14, and is the configuration of the liquid crystal display unit LDU described above excluding the liquid crystal panel 11 and the frame 13. A pair of the LED units LU, which is a part of the backlight device 12, is disposed between the frame 13 and the chassis 14 so as to be on the respective sides of the light guide plate 16, across from each other in the short side direction (Y axis direction). The LED unit LU is constituted of the LEDs 17, which are the light source, an LED substrate (light source substrate) 18 on which the LEDs 17 are mounted, and a heat dissipating member (heat spreader) 19 to which the LED substrate 18 is attached. The respective constituting components will be explained below.

As shown in FIG. 3, the liquid crystal panel 11 is formed in a horizontally long quadrangular shape (rectangular shape) in a plan view, and is configured by bonding a pair of glass substrates 11a and 11b having high light transmittance to each other with a prescribed gap therebetween, and by sealing liquid crystal between the two substrates 11a and 11b. On one of the substrates (the array substrate) 11b, switching elements (TFTs, for example) connected to source wiring lines and gate wiring lines that are intersecting with each other, pixel electrodes connected to the switching elements, an alignment film, and the like are provided. Color filters having colored portions such as R (red), G (green), and B (blue) arranged in prescribed arrays, an opposite electrode, an alignment film, and the like are provided on the other array substrate (CF substrate) 11a. The liquid crystal panel 11 is stacked on the front side of the optical members 15 described below, and the rear surface thereof (outer surface of a polarizing plate on the rear side) is in close contact with the optical members 15 with almost no gap therebetween. With this configuration, dust and the like are prevented from entering the space between the liquid crystal panel 11 and the optical members 15. The display surface 11c of the liquid crystal panel 11 is constituted of a display region that is in the center of the surface and that can display images, and a non-display region that is in the outer edges of the surface and that is formed in a frame shape surrounding the display region. The liquid crystal panel 11 is connected to the control board CTB via a driver part for the liquid crystal and a flexible substrate 26, and based on signals inputted from the control board CTB, images are displayed in the display region on the display surface 11c. Polarizing plates (not shown) are respectively provided on outer sides of the two substrates 11a and 11b.

As shown in FIG. 3, the optical members 15 have a horizontally-long quadrangular shape in a plan view as in the liquid crystal panel 11, and the size thereof (shorter side dimension and longer side dimension) is similar to that of the liquid crystal panel 11. The optical members 15 are stacked on the front side (side from which light is emitted) of the light guide plate 16 described below, and are sandwiched between the liquid crystal panel 11 described above and the light guide plate 16. All of the optical members 15 are sheet-shaped and three optical members are arranged so as to be alternately stacked one on top of the other. Specifically, the optical members 15 are constituted by a diffusion sheet 15a, a lens sheet (prism sheet) 15b, and a reflective polarizing sheet 15c, in that order starting from the rear side (the side with the light guide plate 16). Furthermore, the size of the three sheets 15a, 15b, and 15c in a plan view is approximately the same.

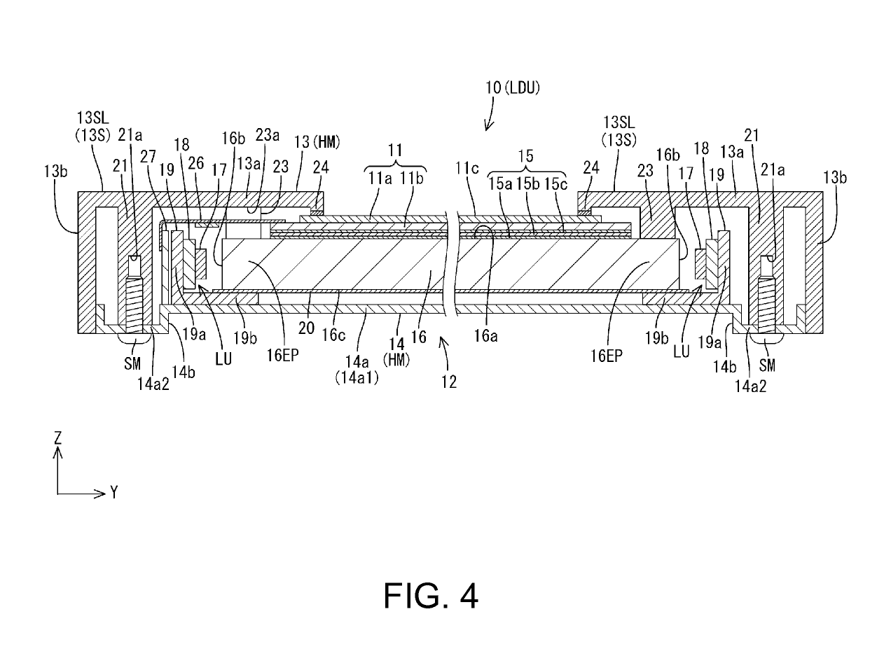

The light guide plate 16 is made of a synthetic resin (an acrylic resin such as PMMA or a polycarbonate, for example) with a higher refractive index than air and almost completely transparent (excellent light transmission). As shown in FIG. 3, the light guide plate 16 has a horizontally-long quadrangular shape in a plan view, in a manner similar to the liquid crystal panel 11 and the optical members 15, and has a plate shape that is thicker than the optical members 15. The long side direction on the main surface of the light guide plate corresponds to the X axis direction, the short side corresponds to the Y axis direction, and the plate thickness direction intersecting the main surface corresponds to the Z axis direction. The light guide plate 16 is placed on the rear side of the optical members 15, and is sandwiched between the optical members 15 and the chassis 14. As shown in FIG. 4, in the light guide plate 16, at least the short side dimensions thereof are greater than the respective short side dimensions of the liquid crystal panel 11 and the optical members 15, and the light guide plate 16 is disposed such that respective edges in the short side direction (respective edges along the long side direction) protrude outward beyond respective edges of the liquid crystal panel 11 and the optical members 15 (so as not to overlap in a plan view). The light guide plate 16 is sandwiched in the Y axis direction between the pair of LED units LU disposed on both edges of the light guide plate 16 facing each other in the short side direction thereof. Light from the LEDs 17 enters both respective edges of the short side direction. The light guide plate 16 has the function of guiding therethrough light from the LEDs 17 that entered from the respective edges facing each other in the shorter side direction and emitting the light toward the optical members 15 (front side) while internally propagating this light.

Of the main surfaces of the light guide plate 16, the surface facing the front side (facing the optical members 15) is a light exiting surface 16a where internal light exits towards the optical members 15 and the liquid crystal panel 11. Of the peripheral end faces adjacent to the main surface of the light guide plate 16, both end faces of the light guide plate 16 in the long side direction along the X axis (both end faces of the respective edges in the short side direction) are light receiving faces 16b that directly face the respective LEDs 17 (LED substrates 18) with prescribed gaps therebetween and that receive light emitted from the LEDs 22. The light-receiving faces 16b are on a plane parallel to that defined by the X axis direction and the Z axis direction (main surface of the LED substrate 18), and are substantially perpendicular to the light exiting surface 16a. The direction along which the LEDs 17 and the light-receiving faces 16b are aligned with respect to each other is the same as the Y axis direction, and is parallel to the light exiting surface 16a.

As shown in FIG. 4, a reflective sheet 20 is provided on the rear side of the light guide plate 16, or namely, on a surface 16c opposite to the light exiting surface 16a (the surface facing the chassis 14). This reflective sheet 20 covers almost the entire surface 16c and can reflect light that exits to the rear side back towards the front side. In other words, the reflective sheet 20 is sandwiched between the chassis 14 and the light guide plate 16. The reflective sheet 20 is made of a synthetic resin, and the surface thereof is a highly reflective white. The shorter side dimension of the reflective sheet 20 is greater than the shorter side dimension of the light guide plate 16, and the respective edges thereof protrude beyond the light-receiving faces 16b of the light guide plate 16 toward the LEDs 17. With the protruding portions of the reflective sheet 20, light that travels diagonally from the LEDs 17 towards the chassis 14 can be reflected efficiently, thereby directing the light toward the light receiving faces 16b of the light guide plate 16. On at least one of the light exiting surface 16a and the surface 16c opposite thereto in the light guide plate 16, reflective parts (not shown) that reflect internal light or diffusion parts (not shown) that diffuse internal light are patterned so as to have a prescribed distribution in the horizontal direction, thereby controlling the light emitted from the light exiting surface 16a to have an even distribution in the horizontal direction.

Next, the LEDs 17, LED substrate 18, and heat dissipating member 19 that constitute the LED unit LU will be explained in that order. As shown in FIGS. 3 and 4, the LEDs 17 of the LED units LU have a configuration in which an LED chip is sealed with a resin on a substrate part that is affixed to the LED substrate 18. The LED chip mounted on the substrate part has one type of primary light-emitting wavelength, and specifically, only emits blue light. On the other hand, the resin that seals the LED chip has a fluorescent material dispersed therein, the fluorescent material emitting light of a prescribed color by being excited by the blue light emitted from the LED chip. This combination of the LED chip and the fluorescent material causes white light to be emitted overall. As the fluorescent material, a yellow fluorescent material that emits yellow light, a green fluorescent material that emits green light, and a red fluorescent material that emits red light, for example, can be appropriately combined, or one of them can be used on its own. Each of the LEDs 17 is of a so-called top-emitting type in which the side opposite to that mounted onto the LED substrate 18 (side facing the light-receiving face 16b of the light guide plate 16) is a primary light-emitting surface 17a.

As shown in FIGS. 3 and 4, the heat dissipating member 19 of the LED unit LU is made of a metal such as aluminum, for example, that has excellent heat conductivity, a side face part 19a to which the LED substrate 18 is attached, and a bottom section 19b that makes surface-to-surface contact with the plate surface of the chassis 14, and these two portions form a bent shape having a substantially L-shaped cross section. The length dimension of the heat dissipating member 19 is substantially the same as the length dimension of the LED substrate 18. The side face part 19a that constitutes a portion of the heat dissipating member 19 rises at a right angle to the bottom section 19b from the bottom section 19b, forming a plate shape parallel to the light receiving face 16b of the light guide plate 16 of the LED substrate 18, in which the longer side direction corresponds to the X axis direction, the shorter side direction corresponds to the Y axis direction, and the thickness direction corresponds to the Z axis direction, respectively. The inner surface of the side face part 19a, namely the surface facing the light guide plate 16, have the LED substrate 18 attached thereto. While the longer side dimensions of the side face part 19a are substantially similar to the longer side dimensions of the LED substrate 18, the shorter side dimensions of the side face part 19a are greater than the shorter side dimensions of the LED substrate 18. The respective edges of the side face part 19a in the shorter side direction protrude outward beyond the respective edges of the LED substrate 18 along the Z axis direction. The outer surface of the side face part 19a, that is, the surface opposite to the surface on which the LED substrate 18 is attached faces a screw attaching portion 21 of the frame 13, which will be later described. That is, the side face part 19a is interposed between the screw attaching portion 21 of the frame 13 and the light guide plate 16. The side face part 19a is configured to rise from the outer edge of the bottom section 19b described below toward the front side, or in other words, toward the frame 13 along the Z axis direction.

As shown in FIGS. 3 and 4, the bottom section 19b of the heat dissipating member 19 is formed in a plate shape that is parallel to the surface of the chassis 14, and the longer side direction corresponds to the X axis direction, the shorter side direction corresponds to the Y axis direction, and the thickness direction corresponds to the Z axis direction, respectively. The bottom section 19b is configured to protrude toward the rear edge of the side face part 19a, or in other words, the edge closer to the chassis 14 toward the inside, or in the direction towards the light guide plate 16. The tip of the bottom section 19b is arranged at the rear side of the light guide plate 16 and at the rear side of the reflective sheet 20. In other words, the bottom section 19b is sandwiched (interposed) between the reflective sheet 20 and the chassis 14. The longer side dimension of the bottom section 19b is substantially the same as that of the side face part 19a. The rear surface of the bottom section 19b, or in other words, the surface facing the chassis 14, makes surface-to-surface contact with the surface of the chassis 14.

Next, the configurations of the frame 13 and the chassis 14 that constitute the exterior member and a holding member HM will be explained. The frame 13 and the chassis 14 are both made of a metal such as aluminum, for example, and have higher mechanical strength (rigidity) and heat conductivity as compared with the case in which the frame 13 and the chassis 14 are made of a synthetic resin. As shown in FIG. 3, the frame 13 and the chassis 14 hold the liquid crystal panel 11, the optical members 15, and the light guide plate 16, which are stacked on top of the other, by sandwiching these stacked components from the front side and the rear side, while housing the pair of LED units LU on the respective edges (respective longer side edges) in the shorter side direction.

As shown in FIG. 3, the frame 13 is formed in a horizontally-long frame shape as a whole so as to surround the display region on the display surface 11c of the liquid crystal panel 11. The frame 13 is constituted of a panel pressing portion 13a that is disposed in parallel with the display surface 11c of the liquid crystal panel 11 and that presses the liquid crystal panel 11 from the front side, and side walls 13b that protrude from the outer edges of the panel pressing portion 13a toward the rear side, and has a substantially L-shaped cross portion. The panel pressing portion 13a is formed in a horizontally-long frame shape similar to the outer edge portion (non-display region, frame portion) of the liquid crystal panel 11, and can press almost the entire outer edge portion of the liquid crystal panel 11 from the front side. The panel pressing portion 13a is made wide enough to cover the optical members 15 and the outer edges of the light guide plate 16 that are located outside of the respective longer sides of the liquid crystal panel 11 in the light radiating direction, and the respective LED units LU from the front side, in addition to the outer edges of the liquid crystal panel 11. The front outer surface of the panel pressing portion 13a (surface opposite to the side facing the liquid crystal panel 11) is exposed to the outside on the front side of the liquid crystal display device 10 similar to the display surface 11c of the liquid crystal panel 11, and constitutes the front side of the liquid crystal display device 10 together with the display surface 11c of the liquid crystal panel 11. On the other hand, the side walls 13b take the form of a substantially angular enclosure that protrudes from the outer edges of the panel pressing portion 13a toward the rear side. The side walls 13b can enclose the liquid crystal panel 11, the optical members 15, the light guide plate 16, and the LED units LU that are housed therein along almost the entire periphery thereof, and also can enclose the chassis 14 on the rear side along almost the entire periphery thereof. The outer surfaces of the side walls 13b along the circumference direction of the liquid crystal display device 10 are exposed to the outside in the circumference direction of the liquid crystal display device 10, and constitute the top face, the bottom face, and the side faces of the liquid crystal display device 10.

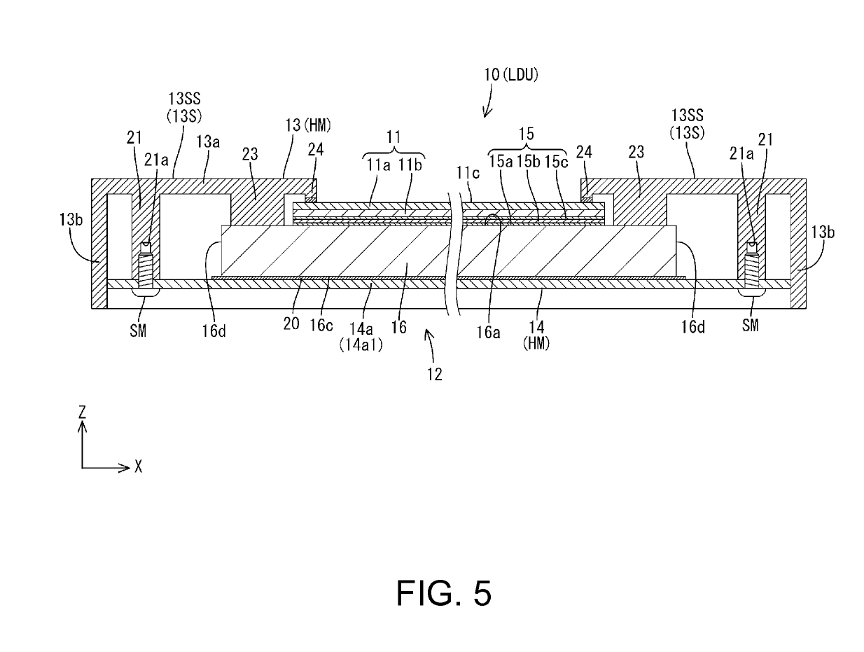

The frame-shaped frame 13 mentioned above that has a basic configuration is configured by assembling four separated frames 13S that are separated at the respective sides (respective longer side portions and shorter side portions). Specifically, the separated frames 13S includes a pair of longer side separated frames 13SL that forms the respective longer side portion of the frame 13 (panel pressing portion 13a and side walls 13b) and a pair of shorter side separated frames 13SS that forms the respective shorter side portions. Furthermore, because the longer side separated frames 13SL cover the respective LED units LU (see FIG. 4) in addition to the liquid crystal panel 11, the optical members 15, and the light guide plate 16, the longer side separated frames 13SL are formed wider compared to the shorter side separated frames 13SS (see FIG. 5) that do not cover the LED unit LU.

The screw attaching portion 21 where a screw SM can be attached is integrally formed on a location further inside from the side walls 13b (close to the light guide plate 16). The screw attaching portions 21 protrude from the inner surface of the panel pressing portion 13a toward the rear side along the Z axis direction, and are each formed in a substantially block shape that is horizontally long and that extends along the respective sides of the panel pressing portion 13a (X axis direction or Y axis direction). As shown in FIGS. 4 and 5, a groove 21a that opens towards the rear side and that allows the screw SM to be fastened is formed in the screw attaching portion 21. On a printed board 27, a plurality of the flexible substrates 26 are arranged at intervals along the longer side direction thereof, and the other ends of the flexible substrates 26 are respectively connected to the printed board 27. The printed board 27 also has a connector to which one end of the FPC is inserted and connected (neither the connector nor FPC is shown in the figures), and the other end of the FPC is led out to the outside on the rear side of the chassis 14 through an FPC insertion hole (not shown) formed in the chassis 14, and is connected to the control board CTB.

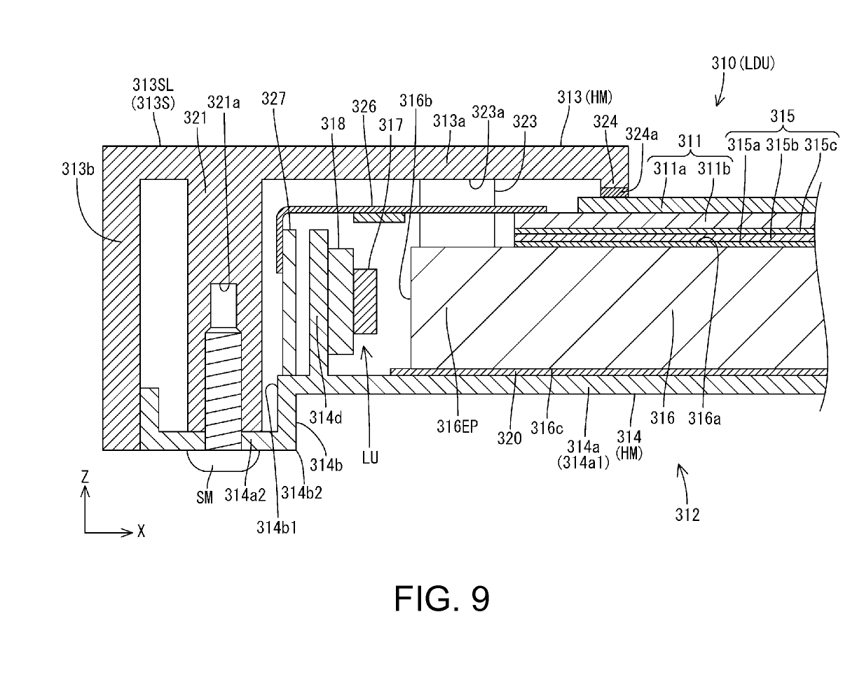

As shown in FIGS. 4 and 5, in the inner edge of the panel pressing portion 13a, a pressing protrusion 24 protruding toward the rear side, or in other words, toward the liquid crystal panel 11 is formed integrally with the panel pressing portion 13a. A buffer member 24a is attached to the protrusion end face of the pressing protrusion 24, and the pressing protrusion 24 can press the liquid crystal panel 11 via the buffer member 24a from the front side. As shown in FIG. 9, the pressing protrusion 24 and the buffer member 24a are separately formed for each side of the separated frames 13S that constitute the frame 13, extending therein, in a manner similar to the screw attaching portion 21, and when the separated frames 13S are assembled together, the pressing protrusion 24 and the buffer member 24a form a frame shape disposed over the entire frame 13, at the inner edge of the panel pressing portion 13a.

As shown in FIG. 3, the chassis 14 is formed in a substantially shallow plate shape that is horizontally long as a whole so as to almost entirely cover the light guide plate 16, the LED units LU, and the like from the rear side. The rear outer surface of the chassis 14 (surface opposite to the side facing the light guide plate 16 and the LED units LU) is exposed to the outside on the rear side of the liquid crystal display device 10, and constitutes the rear surface of the liquid crystal display device 10. The chassis 14 is constituted of a bottom plate 14a formed in a horizontally-long quadrangular shape similar to the light guide plate 16. The bottom plate 14a will be described in detail later.

Next, the configuration of the bottom plate 14a of the chassis 14, which is a main part of the present embodiment, will be described in detail. The bottom plate 14a is configured so as to have a first bottom plate part 14a1 towards the center of the bottom plate and a pair of second bottom plate parts 14a2 on the side edges of the bottom plate. The first bottom plate part 14a1 is in a plate shape slightly larger than the surface 16c on the other side of the light exiting surface 16a of the light guide plate 16, as shown in FIGS. 3 to 5. As shown in FIG. 5, both ends of the first bottom plate part 14a1 extend further out along the longer side direction than the light guide plate 16, and the screws SM that fix the frame 13 and the chassis 14 to each other form a pair of screw attaching portions.

As shown in FIGS. 3 and 4, a pair of the second bottom plate parts 14a2 protrudes from the respective longer side edges of the first bottom plate part 14a1, each forming a step 14b at the respective rear side, and sandwiches the first bottom plate part 14a1 from both sides in the shorter side direction. The second bottom plate part 14a2 has a flat plate shape that has a plate surface that is parallel to the plate surface of the first bottom plate part 14a1, the screw SM being fastened to the second bottom plate part 14a2 from outside. Furthermore, both ends of the second bottom plate parts 14a2 are provided with a pair of side plates that slightly rises towards the front side. The outer surface of a pair of side plates is in contact with the outer frame of the frame 13, and the pair of side plates has a positioning function that determines the position of the chassis 14 to the frame 13 in the Y axis direction.

The second bottom plate parts 14a2 and the first bottom plate part 14a1 are connected through the steps 14b, and the bottom plate 14 is divided into the first bottom plate part 14a1 and the second bottom plate parts 14a2 by the steps 14b. In other words, the steps 14b have been provided by folding the bottom plate 14 in the longer side direction of the chassis 14 in mutually different directions twice, and thus, in the upper edge and the lower edge (between the first bottom plate part 14a1 and the second bottom plate part 14a2) of the steps 14b exist respective folded portions 14b1 and 14b2. Also, the two folded portions 14b1 and 14b2 that form the step 14b in the present embodiment are folded at a right angle in different directions from each other.

As a side note, metals get cracked or bent by folding them, so in general, the folded portion has a higher heat transfer resistance compared to flat portions. Furthermore, in the liquid crystal display device 10 of the present embodiment, the bottom plate 14a of the chassis 14 is metal, and the two folded portions 14b1 and 14b2 are between the first bottom plate part 14a1 and the second bottom plate part 14a2, and thus, compared to cases in which the surface between the first bottom plate part 14a1 and the second bottom plate part 14a2 is flat, heat is difficult to transfer from the first bottom plate part 14a1 to the second bottom plate part 14a2. Here, the heat generated in the LED substrate 18 when the LED 17 of the liquid crystal display device 10 has been lit will be transferred to the first bottom plate part 14a1 through the LED substrate 18 and the heat dissipating member 19. On the other hand, the frame 13 and the second bottom plate part 14a2 are mainly in contact, and because as mentioned above, heat from the first bottom plate part 14a1 is difficult to transfer to the second bottom plate part 14a2, so the majority of the heat generated in the LED substrate 18 is dissipated towards the outside from the first bottom plate part 14a1, and is difficult to transfer to the frame 13 through the second bottom plate part 14a2. Also, the first bottom plate part 14a1 has a large flat shape compared to the second bottom plate part 14a2, and thus compared to the configuration in which the majority of the heat generated in the LED substrate 18 is transferred through second bottom plate part towards the frame 13, the heat is dissipated more effectively to the outside from the first bottom plate part 14a1.

As mentioned above, the liquid crystal display device 10 of the present embodiment has the folded portions 14c1 and 14c2 between the first bottom plate part 14a1 and the second bottom plate part 14a2 that form the steps 14c. Due to this, the heat from the first bottom plate part 14a1 is difficult to transfer to the second bottom plate part 14a2. Whereas the heat generated on the LED substrate 18 attached to the first bottom plate part 14a1 can be transferred to the first bottom plate part 14a1, the heat generated on the LED substrate 18 is difficult to transfer to the frame 13 because the frame 13 is in contact with the second bottom plate part 14a2. As a result, with a simple configuration the temperature of the accessible frame 13 can be prevented from becoming excessively high for the liquid crystal display device 10 without a cabinet.

Furthermore, in the liquid crystal display device 10 of the present embodiment, the steps 14c are formed by the two folded portions 14c1 and 14c2 that are folded at a right angle. In this manner, because the folded portions 14c1 and 14c2 that exist between the second bottom plate part 14a2 and the first bottom plate part 14a1 are folded at a right angle, the heat resistance is higher than cases in which the folded portions are folded at acute or obtuse angles. As a result, heat is even more difficult to transfer from the first bottom plate part 14a1 to the second bottom plate part 14a2, and the temperature of the accessible frame 13 can be effectively prevented from rising excessively.

Also, in the liquid crystal display device 10 of the present embodiment, the bottom plate 14a of the chassis 14 has the first bottom plate part 14a1 located towards the center, and the second bottom plate part 14a2 located at the side edges of the chassis. As a result, a specific configuration of the liquid crystal display device 10 that includes the light guide plate 16 and the like in the central portion of the frame 13 is realized along with the outer edge of the frame 13 being in contact with the second bottom plate part 14a2.

Furthermore, in the liquid crystal display device 10 of the present embodiment, there are the heat dissipating members 19 with heat dissipating characteristics interposed between the first bottom plate part 14a1 and the LED substrate 18. Also, the heat dissipating member 19 has the bottom face part 19b that is arranged along the first bottom plate part 14a2 and the side face part 19a that rises from the bottom face part 19b at a right angle to the bottom face part 19b, and has an L-shape in a cross-sectional view, and the LED substrate 19 is arranged on the side surface 19a. As a result, the heat in the LED substrate 19 can be effectively dissipated to the first bottom plate part 14a1 by the heat dissipating member 19. Furthermore, a specific configuration has been realized due to the LED substrate 19 effectively transferring heat to the first bottom plate part 14a1 through the heat dissipating member 19.

Also, in the liquid crystal display device 10 of the present embodiment, the second bottom plate part 14a2 is the portion protruding in the opposite direction to the liquid crystal panel 16 from the first bottom plate part 14a1 due to the steps 14c. As a result, in this configuration it is easier to sandwich the LED substrate 18 and the light guide plate 16 between the frame 13 and the chassis 14 compared to when the second bottom plate part 14a2 protrudes further towards the liquid crystal panel 16 than the first bottom plate part 14a1.

Furthermore, in the liquid crystal display device 10 of the present embodiment, problems due to the increase in the number of components such as the manufacturing process becoming more complicated and the cost of the materials rising will not occur because the heat generated in the LED substrate 18 can be effectively dissipated to outside of the device without adding another member such as a heat dissipating member.

### Embodiment 2

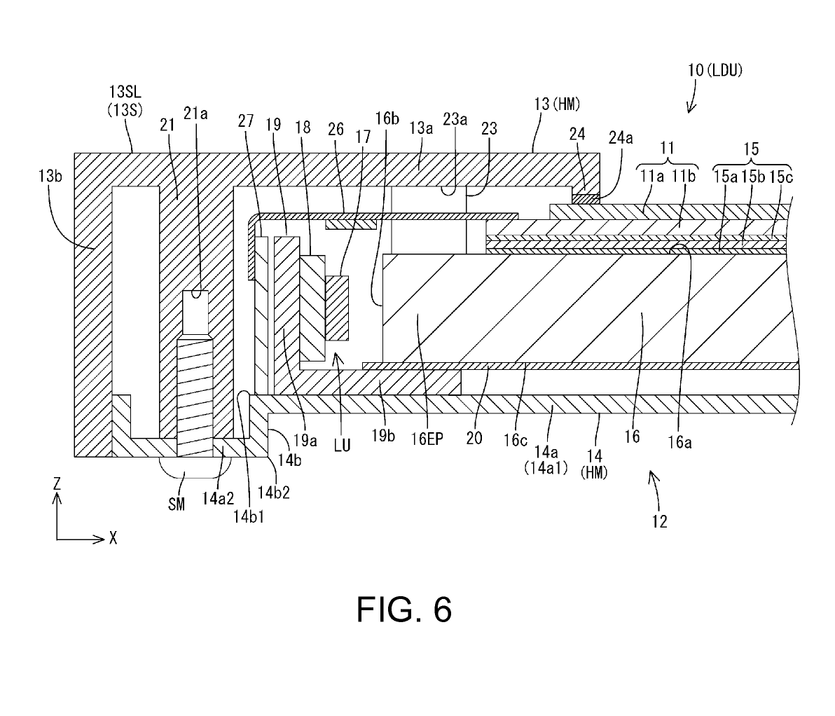

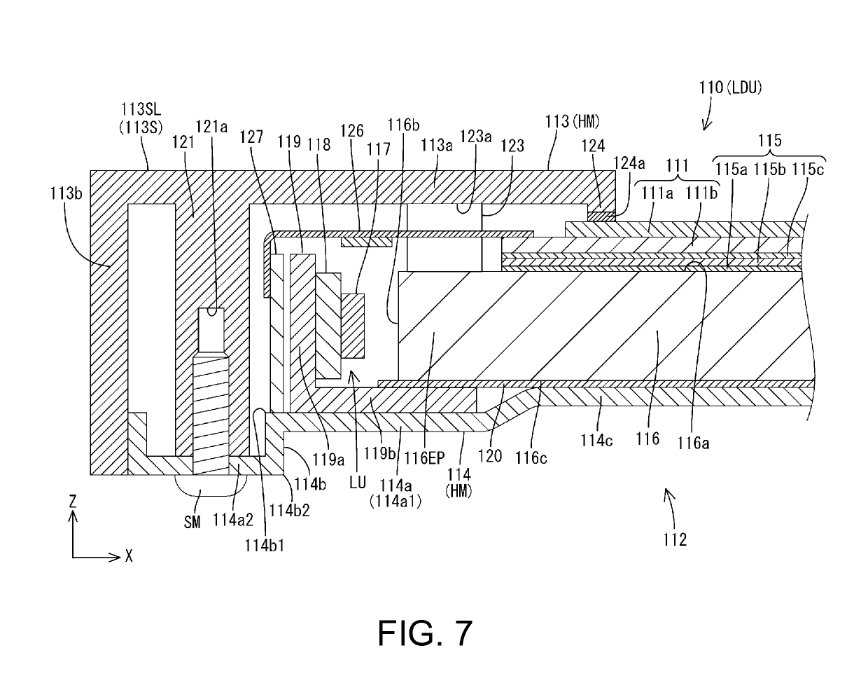

Embodiment 2 will be described with reference to the drawings. Embodiment 2 differs from Embodiment 1 in the configuration of the bottom plate of the chassis. Other elements are similar to those of Embodiment 1, and therefore, descriptions of the configurations, the operation, and the effect will be omitted. Parts in FIG. 7 that have 100 added to the reference characters of FIG. 6 are the same as these parts described in Embodiment 1.

As shown in FIG. 7, a liquid crystal display device 110 of Embodiment 2 is provided with a third bottom plate 114c that protrudes towards a liquid crystal panel 116 (front side) through a step with equal thickness to a bottom face part 119b of a heat dissipating member 119 in the center portion of a first bottom plate part 114a1 in a bottom plate 114a of a chassis 114. The step provided between the first bottom plate part 114a1 and the third bottom plate 114c has a smooth slope, and the plate surface of the third bottom plate 114c is in parallel with the plate surface of the first bottom plate part 114a1 and the plate surface of a second bottom plate part 114a2. As a result, the bottom face part 119b of the heat dissipating member 119 and the plate surface of the third bottom plate 114c are arranged on the same plane, and a reflective sheet 120 is placed on the plate surface on the front side of the third bottom plate 114c. Thus, on the plate surface on the front side of the third bottom plate 114c, a light guide plate 116 is supported via the reflective sheet 120. The liquid crystal display device 110 of Embodiment 2 is configured so that the light guide plate 116 can be easily supported. This is possible due to the configuration of the bottom plate 114a of the chassis 114, the bottom face part 119b of the heat dissipating member 119, and the plate surface of the third bottom plate 114c supporting the light guide plate 116.

### Embodiment 3

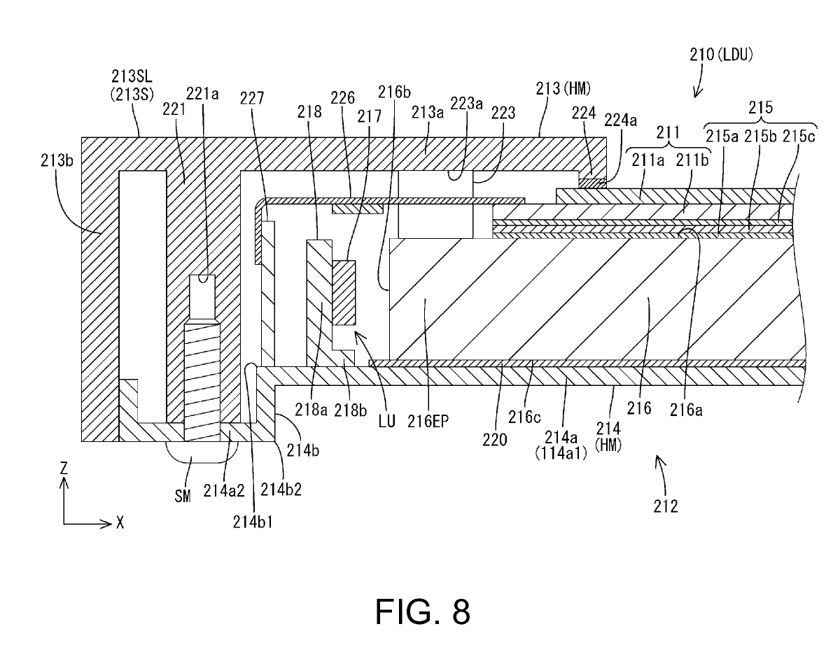

Embodiment 3 will be described with reference to the drawings. Embodiment 3 differs from Embodiment 1 in that there are no heat dissipating members. Other elements are similar to those of Embodiment 1, and therefore, descriptions of the configurations, the operation, and the effect will be omitted. Parts in FIG. 8 that have 200 added to the reference characters of FIG. 6 are the same as these parts described in Embodiment 1.

As shown in FIG. 8, a liquid crystal display device 210 of Embodiment 3 does not have a heat dissipating member interposed between an LED substrate 218 and a first bottom plate part 214a1 of a chassis 214, and the liquid crystal display device is configured so that the LED substrate 218 is directly attached to the first bottom plate part 214a1. The LED substrate 218 is configured so as to have two plate-shaped portions 218a and 218b in a substantially L shape in a cross-sectional view. Among the two plate-shaped portions, the plate-shaped portion 218b is arranged along the plate surface of the first bottom plate part 218, and the other plate-shaped portion 218a rises vertically from the plate-shaped portion 218b, and an LED 217 is arranged on a plate surface opposing a light guide plate 216. The liquid crystal display device 210 of Embodiment 3 can be made to easily transfer heat from the LED substrate 218 to the first bottom plate part 214a1 of the chassis 214 without arranging a heat dissipating member or a light source attachment member because the LED substrate 218 can be directly attached to the first bottom plate part 214a1 as described.

### Embodiment 4

Embodiment 4 will be described with reference to the drawings. Embodiment 4 is different from Embodiment 1 in that it is provided with a light source attachment member 314e on a bottom plate 314a of a chassis 314. Other elements are similar to those of Embodiment 1, and therefore, descriptions of the configurations, the operation, and the effect will be omitted. Parts in FIG. 9 that have 300 added to the reference characters of FIG. 6 are the same as these parts described in Embodiment 1.

As shown in FIG. 9, the liquid crystal display device 310 of Embodiment 4 does not have a heat dissipating member, is formed on and integrally with a first bottom plate part 314a1 of the chassis 314 and is provided with a substrate attachment member 314d that rises at a right angle towards a liquid crystal panel 316 (front side) from the first bottom plate part 314a1. Also, an LED substrate 318 is arranged on a plate surface opposing a light guide plate 316 of the substrate attachment member 314d. With this configuration, the liquid crystal display device 310 of the Embodiment 4 can easily transfer heat from the LED substrate 318 to the first bottom plate part 314a1 without arranging a heat dissipating member or the like. Furthermore, such a configuration easily transfers heat from the LED substrate 318 side to the first bottom plate part 314a1 side compared to configurations with other members such as heat dissipating members being interposed between the LED substrate 318 and the first bottom plate part 314a1, due to the substrate attachment member 314d being integrally formed with the first bottom plate part 314a.

Modification examples of the respective embodiments above will be described below.

(1) In the respective embodiments, the examples provided had a step provided between a first bottom plate part and a second bottom plate part configured so that the step has two folded portions folded at a right angle, but the folding angle of the two folded portion is not limited thereto.

(2) In the respective embodiments, an example provided had a second bottom plate part extending from both sides of a first bottom plate part in a longer side direction, but the configuration of the first bottom plate part and the second bottom plate part on a bottom plate of a chassis is not limited thereto.

(3) In the respective embodiments, an example showed a configuration with a step formed with two folded portions provided between a first bottom plate part and a second bottom plate part, but there may be a plurality of steps with three or more folded portions between the first bottom plate part and the second bottom plate part.

(4) The shape of the bottom plate of the chassis, the configuration, the location of the step on the bottom plate, the form, and the like can be different from the above-mentioned embodiments and be appropriately modified.

(5) In the respective embodiments above, a liquid crystal display device using a liquid crystal panel as a display panel was shown as an example, but the present invention is also applicable to a display device that uses another type of display panel.

Embodiments of the present invention were described above in detail, but these are merely examples, and do not limit the scope defined by the claims. The technical scope defined by the claims includes various modifications of the specific examples described above.

Also, the technical elements described in the present specification or shown in the drawings realize technical utility each on their own or through a combination of various technical elements, and are not limited to the combinations defined by the claims at the time of filing. Also, the techniques described in the present specification or shown in the drawings can accomplish a plurality of objects simultaneously, and each one of the objects on its own has technical utility.

### DESCRIPTION OF REFERENCE CHARACTERS

TV television receiver
LDU liquid crystal display unit
PWB power supply board
MB main board
CTB control board
CV cover member
ST stand
LU LED unit
10, 110, 210, 310 liquid crystal display device
11, 211, 311 liquid crystal panel
12, 112, 212, 312 backlight device
13, 113, 213, 313 frame
14, 114, 214, 314 chassis
14a, 114a, 214a, 314a bottom plate
14a1, 114a1, 214a1, 314a1 first bottom plate part
14a2, 114a2, 214a2, 314a2 second bottom plate part
14b, 114b, 214b, 314b step
14c1, 14c2, 114c1, 114c2, 214c1, 214c2, 314c1, 314c2 folded portion
15, 115, 215, 315 optical members
16, 116, 216, 316 light guide plate
17, 117, 217, 317 LED
18, 118, 218, 318 LED substrate
19, 119 heat dissipating member
20, 120, 220, 320 reflective sheet

1. A display device, comprising:
a light source;
a display panel that performs display with light from the light source;
a light guide plate disposed on a side of the display panel opposite to a display surface side thereof, the light guide plate being disposed such that an end face thereof faces the light source, the light guide plate guiding light from the light source towards the display panel;
a chassis made of metal arranged on a side of the light guide plate opposite to the display panel and having a bottom plate, the bottom plate having a step formed by folding said bottom plate such that the step divides the bottom plate into a first bottom plate part and a second bottom plate part;
a light source substrate attached to the first bottom plate part of the chassis, the light source substrate having the light source arranged on a surface thereof; and
a frame arranged on the display surface side of the display panel, the frame contacting the second bottom plate part of the chassis and sandwiching the display panel, the light source, the light guide plate, and the light source substrate with the first bottom plate part of the chassis.

2. The display device according to claim 1, wherein the step is formed with two folded portions that are folded at a right angle.

3. The display device according to claim 1, wherein the bottom plate has the first bottom plate part located towards a center of the bottom plate and has the second bottom plate part located towards a side edge of the bottom plate.

4. The display device according to claim 1, further comprising a heat dissipating member with heat dissipating characteristics interposed between the first bottom plate part and the light source substrate.

5. The display device according to claim 4, wherein the heat dissipating member has a bottom face part having a surface arranged on the first bottom plate part and has a side face part that rises vertically from the bottom face part so as to form an L shape in a cross-sectional view, the light source substrate being arranged on said side face part.

6. The display device according to claim 5, wherein the bottom plate of the chassis has a third bottom plate part surrounded by the first bottom plate part, a surface of the third bottom plate part being raised towards the display panel relative to a surface of the first bottom plate part by an amount equal to a thickness of the heat dissipating member.

7. The display device according to claim 1,
wherein the first bottom plate part has a substrate attachment member that is integrally formed with the first bottom plate part and that rises vertically from the first bottom plate part, and
wherein the light source substrate is arranged on the substrate attachment member.

8. The display device according to claim 1,
wherein the light source substrate includes two plate shaped portions forming an L shape in a cross-sectional view,
wherein one of the plate shaped portions is arranged on the first bottom plate part, and
wherein the light source is provided on another of the plate shaped portions.

9. The display device according to claim 1, wherein the second bottom plate part protrudes in a direction opposite to the display panel from the first bottom plate part due to the step.

10. The display device according to claim 1, wherein the display panel is a liquid crystal panel having liquid crystal.

11. A television receiver, comprising the display device according to claim 1.
